(19) United States
(12) Patent Application Publication
(10) Pub. No.: US 2015/0142399 A1
(43) Pub. Date: May 21, 2015

(54) EXACT PARAMETER SPACE REDUCTION

(71) Applicant: Toyota Motor Engineering & Manufacturing North America, Inc., Erlanger, KY (US)

(72) Inventors: Erik Jelle Postma, Waterloo (CA); Jürgen Gerhard, Waterloo (CA); Elena Shmoylova, Waterloo (CA); Austin Duncan Roche, Waterloo (CA)

(21) Appl. No.: 14/570,465

(22) Filed: Dec. 15, 2014

Related U.S. Application Data
(63) Continuation-in-part of application No. 12/948,169, filed on Nov. 17, 2010.

(51) Int. Cl. G06F 17/50; G06F 17/13

(52) U.S. Cl. CPC G06F 17/5009; G06F 17/13
USPC 703/2

(57) ABSTRACT

In a computational environment including at least one processor, an example method of reducing the number of symbolic parameters in a model of a physical system includes receiving an initial model such as a system of differential algebraic equations (DAEs), eliminating isolated symbolic parameters (if any) from the initial model, extracting parameter sub-expressions from the DAEs, establishing minimal disconnected clusters of parameter sub-expressions, and for each cluster, attempting to generate a reduced cluster having a reduced number of symbolic parameters using one or more algorithms. If more than one approach is successful, that which is most successful in reducing the number of symbolic parameters is selected. A revised model is created having fewer symbolic parameters than the initial model and based on simulation results obtained from the revised model, a prototype of a physical system is manufactured and/or changes are made to an existing physical system.

### CROSS-REFERENCE TO RELATED APPLICATIONS

This application is a continuation-in-part of U.S. patent application Ser. No. 12/948,169 filed Nov. 17, 2010.

### FIELD OF THE INVENTION

The invention relates to improved apparatus and methods for mathematical modeling of physical systems, in particular parameter reduction within differential equations.

### BACKGROUND OF THE INVENTION

In engineering development, prototyping and testing can be replaced by virtual modeling and simulation. A physical system can be represented by a mathematical model within a software modeling and simulation environment. Simulation can be achieved on a computer for various scenarios. Improved simulation approaches allow more rapid development and prototyping. In the early stages at least, prototyping using physical objects can be replaced by virtual modeling. Hence, improved simulations allow more rapid development of products or processes. Any approaches that reduce modeling complexity and simulation times allow more extensive use of virtual modeling, reducing product development times and having other commercial uses.

Hence, improved simulation methods are of considerable value and interest in a variety of technical fields.

### SUMMARY OF THE INVENTION

Differential equations are used in mathematical models of various physical systems. These differential equations include a plurality of symbolic parameters, which are constant during simulation of the model but which can be varied between separate simulation runs. It is highly advantageous to rewrite the differential equations using fewer symbolic parameters, while retaining the same behavior. Examples disclosed herein invention allow parameter reduction within systems of differential equations, and include a variety of approaches to the parameter reduction. The reduction in symbolic parameters improves applications of the simulation, such as calibration, parameter identification, and general studies of a dynamic system. Simulation times can be significantly reduced, speeding virtual modeling and verification of such models. Simulation times can be reduced because fewer simulations are necessary. It is appreciated that the reduction in symbolic parameters, which improves applications of various types of simulations, also improves the designing and/or manufacturing of physical systems.

Examples disclosed herein include novel algorithmic approaches to simplifying physical models by reducing the number of symbolic parameters. Examples disclosed herein include both novel algorithms and novel uses of existing algorithms for reducing the number of symbolic parameters, including functional decomposition approaches.

An example parameter reduction approach includes one or more of the following approaches. Parameter sub-expressions may be extracted from a system of differential algebraic equations (DAE). Minimum disconnected clusters of sub-expressions are established. For each cluster, an attempt is made to reduce to a polynomial in one parameter. An attempt is also made to reduce each cluster to a polynomial in linear expressions of the symbolic parameters. A heuristical technique may then be used to reduce each cluster to a decomposition in general expressions. After using one or more approaches such as described herein, the approach which leads to the strongest reduction in the number of symbolic parameters is selected. A modified system of DAEs is returned with the parameter reductions applied. Thereafter a physical system is modeled using the modified system of DAEs, and based on modeling results, a prototype of a physical system or a modification to an existing physical system is manufactured.

A DAE is returned that has fewer symbolic parameters than the original model, but is still exactly equivalent. Testing runs or parameter optimization runs can be performed over a lower dimensional space, which increases efficiency dramatically. For a given effort, testing coverage can be significantly increased. Further, the total number of not globally identifiable symbolic parameters is reduced.

### BRIEF DESCRIPTION OF THE FIGURES

FIG. 1 shows a flowchart of an example approach;

FIG. 2 is schematic illustration of a specifically configured computer according to an embodiment disclosed herein;

FIG. 3 is a schematic circuit diagram for a physical system that is model with a system of DAEs and the system of DAEs are subjected to symbolic parameter reduction; and

FIG. 4 is a schematic flowchart of a process disclosed herein.

### DETAILED DESCRIPTION OF THE INVENTION

A differential algebraic equation (DAE) system has some number of time-independent symbolic parameters (hereafter also referred to as “parameters”). Examples disclosed herein relate to finding a revised model, such as a revised DAE system, exhibiting the same or very similar behavior, but using fewer symbolic parameters. In modern engineering development processes, prototyping and testing is replaced by virtual modeling and simulation. Stated differently, an original DAE system with a plurality of symbolic parameters is transformed into a revised DAE system with a reduced number of symbolic parameters.

In some instances, a mathematical model of a physical system is designed in a software modeling and simulation environment, and the simulation is then performed using a computer. A computational bottleneck is the number of symbolic parameters to be identified and/or optimized. Generally, the more unknown symbolic parameters there are in a mathematical model, the longer it takes to perform the computational tasks of parameter identification and parameter optimization. Hence, it is highly desirable to reduce the number of symbolic parameters, preferably to a number as small as possible.

Examples disclosed herein include removal of any symbolic parameters from a mathematical model that are redundant or not identifiable. By reducing the number of symbolic parameters, the running time and complexity of subsequent steps in a modeling process can be reduced. The accuracy of subsequent steps may also be increased. Hence, examples disclosed herein include approaches which may dramatically speed up and may also improve the accuracy of subsequent modeling using a mathematical model. Naturally the increase in speed and/or accuracy of subsequent modeling of a physical system reduces time and cost associated with manufacturing the physical system.

A revised DAE system is produced which has fewer symbolic parameters than the original system, while not introducing any new behaviors into the model. New behaviors are those that would not be exhibited by the initial model for the same inputs. In parameter reduction disclosed herein (also referred to as “exact parameter reduction”), the revised system reproduces accurately the behavior of the old system, while using fewer symbolic parameters. Mathematical proofs are given in more detail below, showing how exact parameter reduction can be obtained.

A physical model in DAE form includes a number of states, terms symbolic parameters, inputs, outputs, and typically includes time as the independent variable. Exact parameter reduction provides the same model in a different mathematical form including a lower number of symbolic parameters. For example, sub-expressions of the DAE include the symbolic parameters, but not states, inputs, outputs, or time. Also, the sub-expressions can be reformulated in terms of a smaller number of symbolic parameters. After symbolic parameter sub-expression extraction, a number of techniques can be used for symbolic parameter reduction. In general, it is best to extract sub-expressions that involve as many symbolic parameters as possible, because such sub-expressions provide the largest potential for parameter reduction. After reducing the number of symbolic parameters in a sub-expression, the reduced-parameter sub-expression can be substituted into the original DAE system.

A parameter in a DAE model is a quantity that remains constant over time. Exact parameter space reduction expresses the model as a different DAE model having the same dynamic behavior but fewer symbolic parameters. The states and outputs of the revised model preferably have the same value as those of the original model if the two models are given the same input. By performing parameter space reduction, the dimensionality of the test space is reduced. Hence, fewer tests are necessary, and a validation phase of the model is shortened. Model calibration is also simplified using the lower dimensional symbolic parameter space. An example approach includes extracting symbolic parameter sub-expressions from the DAE system. Next, minimal disconnected clusters of the sub-expressions are established. One or more approaches to reduce the number of symbolic parameters and preferably reduce the cluster to a single symbolic parameter polynomial are then attempted for each cluster. An attempt is made to reduce the symbolic parameters occurring in the cluster to one or more linear combinations of symbolic parameters.

The cluster itself may be non-polynomial (and thus nonlinear), and an attempt is made to find new symbolic parameters that are linear expressions in terms of the original symbolic parameters. A heuristical attempt can be used to decompose the clusters in general expressions. The heuristical approach (or other approach described herein, such as the inside linear and uni-multivariate approach) may be omitted or varied. After attempting one or more of such approaches, the approach leading to the largest reduction in symbolic parameters is selected. The DAE system is then reformulated with the symbolic parameter reductions applied, and the modified DAE model represents the output of the operation disclosed herein. In addition, the modified DAE model can be used to model/simulate a physical system with the results of the modeling used to design, modify and/or manufacture a prototype of the physical system or modify an existing physical system. Exemplary physical system include but are not limited to direct current (DC) motors, alternating current (AC) motors, internal combustion engines, components of internal combustion engines, HVAC units, components of HVAC units, drive train units of motor vehicles, components of drive units of motor vehicles, steering systems for motor vehicles, components of steering systems for motor vehicles, braking systems for motor vehicles, ignition systems for motor vehicles, components of ignition systems for motor vehicles, tires for motor vehicles, safety systems for motor vehicles, components of safety systems for motor vehicles, and the like.

Exact parameter space reduction has at least three advantages over approximate parameter space reduction. The methods are directly applicable to nonautonomous models. It is possible to define new symbolic parameters as arbitrary expressions of original symbolic parameters. The reparameterizations are generally valid. However exact parameter reduction may not succeed if only approximate reparameterizations are applicable to the model.

Before attempting parameter reduction, an elimination code is applied to the models. Any variable in the model can be an obstruction to eliminating a parameter, hence it is preferable that unnecessary variables are eliminated before attempting parameter reduction.

A meta-algorithm can be used as the entry point to the parameter reduction process within a virtual engineering environment. The meta-algorithm calls all other algorithms used. The meta-algorithm receives a physical model represented by a list of equations, partitions the model into clusters, runs the different decomposition algorithms on these clusters, and chooses the best result for each cluster. It then reassembles the chosen cluster into a revised model and returns this to the user.

The output is a simplified model, including a list of expressions or equations representing the simplified models in terms of new symbolic parameters and possibly some of the original symbolic parameters. The output includes a set of original symbolic parameters and a list of definitions of new symbolic parameters. The new symbolic parameters are defined in terms of original symbolic parameters. If the definitions of the new symbolic parameters are substituted into the original model, this gives expressions that are mathematically equivalent to the original expressions. The simplified model contains fewer symbolic parameters than the original expressions. In some examples, no new symbolic parameters are determined, and in this case nothing will have changed (the output model will be the same as the input model, and there will be no substitutions).

Isolated parameter filtering can also be used to enhance the efficiency of the process. Effort trying to reduce the parameter space is wasted if it can be deduced beforehand that it will not work. For example, if an equation contains only one parameter, parameter reduction is not possible with the techniques described herein and it is inefficient to attempt to remove that parameter. A parameter is isolated if there is an equation where all other symbolic parameters occurring in that equation are already known to be isolated. This is always true if there is only one parameter in a given equation.

A clustering algorithm can be used to partition the model into independent clusters. The clusters are sets of nonisolated symbolic parameters, defined with respect to one particular model. The clusters partition the nonisolated symbolic parameters, so that every nonisolated parameter is in a single cluster. If one expression includes several nonisolated symbolic parameters, all those symbolic parameters should be in the same cluster. Clusters should be as small as possible. An advantage of clustering is that it separates the nonisolated symbolic parameters into subsets of symbolic parameters that need to be dealt with together. The subsets can then be dealt with independently. For example, one parameter reduction algorithm may be applied to one cluster, whereas a different parameter reduction algorithm may be better with a different cluster. However, no algorithm may succeed on the union of those two clusters. The use of clusters allows different algorithms to be applied to different parts of the model. Preferably, clustering occurs after the filtering and removal of isolated symbolic parameters. The meta-algorithm sends the clusters to one or more parameter reduction algorithms, as described herein; the best algorithm for each cluster is identified; and a revised model is assembled from the processed clusters.

A number of parameter reduction approaches were developed. A first approach is referred to as the inside linear approach, or inside linear algorithm.

An example inside linear decomposition algorithm takes a list of expressions or equations and attempts to find a reparameterization to fewer symbolic parameters, such that the new symbolic parameters are linear combinations of the original symbolic parameters. If such a reparameterization exists, the algorithm finds it. The algorithm is halted if no such reparameterization exists. The inside linear algorithm may be called from the meta-algorithm described earlier.

The inside linear algorithm (first algorithm) attempts to find a linear reduction of parameter expressions. The input comprises a list of expressions or equations, typically part of a model. A set of symbolic parameters to be considered may also be included.

If successful, a list of new expressions or new equations replaces the input expressions. These expressions are expressed in terms of new symbolic parameters. The output model has a list of new symbolic parameters expressed in terms of original symbolic parameters, and any original symbolic parameters that are unchanged. Substituting the new symbolic parameters yields a list of expressions that are mathematically equivalent to the original expressions. However, the new parameter list has fewer symbolic parameters than the original symbolic parameters.

A high level description of the algorithm is given below, in which a Jacobian is calculated. Symbolic row reduction then is performed on the Jacobian. A mathematical proof is given later in the specification that this optimization approach is valid in all cases.

A second approach to parameter reduction is the uni-multivariate polynomial decomposition algorithm. Existing algorithms may be adapted for use in this novel objective. Existing algorithms can be used to write a single multivariate polynomial as the composition of a univariate polynomial, and a second multivariate polynomial. Hence, this tells us whether there exists a decomposition where the “outer” polynomial is univariate. There may be a decomposition where the “outer” polynomial has two or more variables (i.e., the reduction would lead to two or more new symbolic parameters), which would not be found by this algorithm.

For the first time, this type of approach is used considering multiple polynomials simultaneously as input. Polynomial sub-expressions are extracted from the physical model. The model may include n symbolic parameters occurring in k sub-expressions. The uni-multivariate polynomial decomposition algorithm determines if there are k univariate polynomials (g) and one multivariate polynomial (h), such that for some or all symbolic parameters, f can be expressed as a composition of g and h. In that case, a new parameter can be defined as the polynomial (h) in terms of n symbolic parameters. This corresponds to a fortunate case of parameter reduction, where the n symbolic parameters are reduced to a single new parameter. A more detailed description of this algorithm is given below.

A third approach is termed a heuristical decomposition. In this algorithm, one or more reparameterizations are attempted, which may arise from rules of thumb and not supported by mathematical theorems. If a result is found, it will be valid, but the class of reparameterizations is difficult to describe beforehand. The heuristical decomposition algorithm is input parameter sub-expressions that were extracted from the model. No non-parameter quantity should be part of the input. One approach is to simply take the set of parameter sub-expressions as new symbolic parameters. This found reparameterizations that occasionally were not valid. An invalid reparameterization is one that provides a model that has new behavior. However, in such cases the inside linear method and uni-multivariate methods both find a better solution and this will be selected by a meta-algorithm.

Another heuristical approach attempts to reduce the number of symbolic parameters by trying to express some of the larger parameter sub-expressions in terms of smaller sub-expressions. Other approaches may be used, according to known rules of thumb.

The meta-algorithm calls a sub-expression extraction algorithm, and the extracted sub-expressions are fed to one or more parameter reduction algorithms, which may include a heuristical approach. A heuristical algorithm input may be a list of parameter expressions, typically part of a model such as a minimal disconnected cluster, and a set of symbolic parameters to be considered. The output, if successful, includes a list of new expressions or equations replacing the input expressions, which can be expressed in terms of new symbolic parameters. The output may also include new symbolic parameters and a list of values that the new symbolic parameters represent (expressed in terms of the original symbolic parameters). Hence, a list of expressions can be obtained that are mathematically equivalent to the input expressions. However, when the algorithm is successful, there are fewer new symbolic parameters than input symbolic parameters. The new expressions may not contain any of the original symbolic parameters. The heuristical approach is described in more detail elsewhere in this specification.

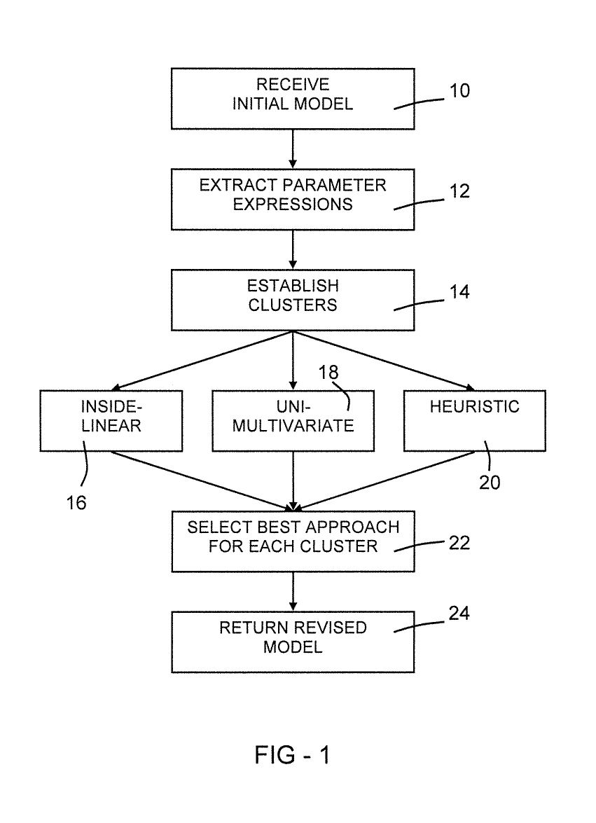

FIG. 1 illustrates a flowchart according to an example of the present invention. Box 10 corresponds to receiving the initial model, for example a system of DAEs. Box 12 represents extracting parameter sub-expressions from the model. At this point, isolated symbolic parameters are preferably eliminated. Box 14 represents establishing minimal disconnected clusters of sub-expressions. Box 16 corresponds to, for each cluster, attempting to find an expression in linear combinations of the symbolic parameters, for example using an inside-linear algorithm. Box 18 represents, for each cluster of sub-expressions, attempting to find a polynomial in one parameter, for example using a uni-multivariate algorithm. Box 20 corresponds to, for each cluster, attempting a heuristical approach to reduce the clusters to a decomposition in general expressions. Box 22 corresponds to selecting, for each cluster, the approach (if any) that gave the largest reduction in the number of symbolic parameters. If no parameter reduction approach was successful, the cluster is unchanged. Box 24 corresponds to returning a revised DAE with the strongest reduction in symbolic parameters applied.

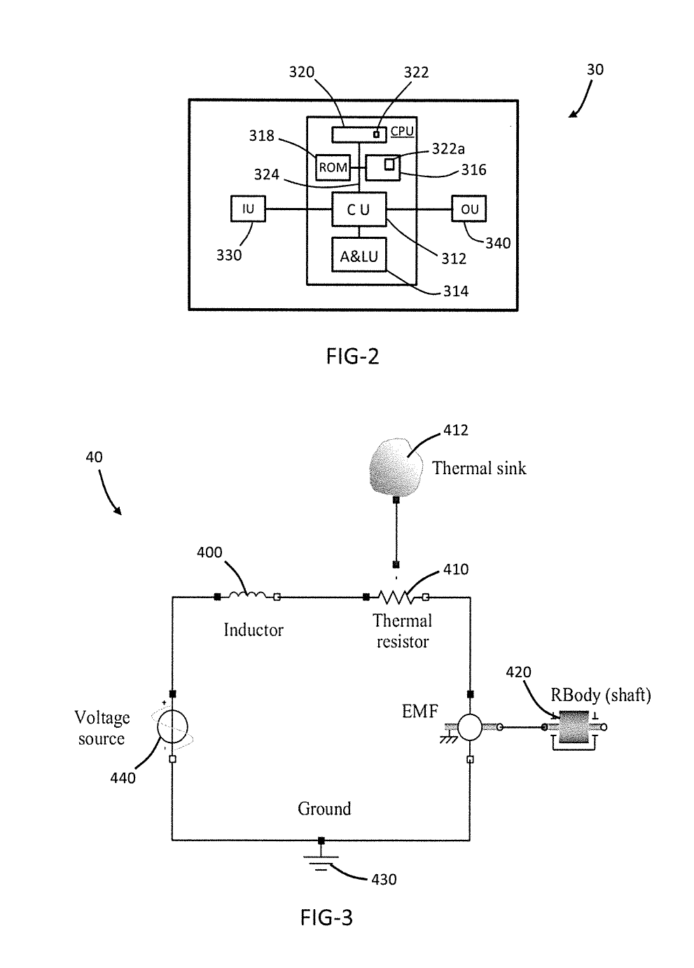

Examples disclosed herein may be implemented in a virtual engineering modeling environment, which may include a computer system comprising one or more of the following: a processor, memory component, user interface, input/output device, data buses providing communications between various components, and the like. For example, FIG. 2 illustrates a computer 30 with a central processing unit (CPU) 310. The CPU 310 includes a control unit 312 and an arithmetic and logic unit 314. The CPU 310 also includes memory, such as ready access memory (RAM) 316 and read-only memory (ROM) 318. Additional storage 320 can also be present. A software module 322 and/or 322a can be located on the storage 320 and/or RAM 316. As is known to those skilled in the art, a software module can be permanently stored on storage 320 and then when initiated have a portion thereof stored on RAM 316. It is also appreciated that the controller unit 312 is in communication with the various other components of the CPU via one or more buses 324. The computer 30 also includes an input unit 330 and an output unit 340.

The modeling environment may include a network of computers. An initial configuration of the modeling environment, such as a computer system, includes the initial model of a physical system. The computer system allows test and verification of the physical system within the virtual engineering environment. This allows prototyping, but the time required for virtual engineering activities can be excessive if the model is complex and includes many symbolic parameters. This may prevent the practical use of virtual engineering, requiring real models to be built and tested. However, examples disclosed herein allow improved system modeling and virtual prototyping by replacing the initial model with a revised model that uses fewer symbolic parameters. The revised model may allow significantly faster computation of model predictions and behavior. This allows realization of the virtual engineering advantages such as reduced prototyping time and faster product development.

The revised model may have exactly the same properties, or at least arbitrarily similar properties, to the original model, while reducing computational demands. A previously impractical complex model may be used by reducing the number of symbolic parameters, and hence reducing the computational demands of the model. Hence, using examples of the present invention, the use of virtual engineering can be expanded.

By reducing the number of symbolic parameters within a model, the running time and complexity of subsequent steps in the modeling process are both reduced. This may also increase the accuracy of the subsequent steps, speeding up and improving the accuracy of subsequent steps in the modeling process.

### Further Details of the Approaches

A variation of the functional decomposition problem is examined where the quantity to be minimized is the dimension of the intermediate space. This problem is relevant to numerically integrating parameterized differential equations. A number of example methods are described, including the inside linear (algorithm 1), uni-multivariate (algorithm 2), and heuristical (algorithm 4) methods. As described below, algorithm 3 is a subroutine of algorithm 4. The three approaches can be used independent of each other or in conjunction.

The inside-linear method (algorithm 1) is a novel method of exact parameter reduction. The uni-multivariate method (algorithm 2) is related to existing functional decomposition algorithms, but has been modified for the novel purpose of parameter reduction. A conventional functional decomposition approach considers linear factors trivial, unlike the present approach. However, the known algorithms for functional decomposition happen to work for linear factors as well. Further, the known methods for uni-multivariate decomposition considers the decomposition of a single polynomial only, but here algorithm 2 is generalized to work for decomposing multiple polynomials simultaneously. The heuristical method (algorithms 3 and 4) are original methods of parameter reduction. Symbolic parameters that are not globally identifiable are removed. The described methods are computationally very efficient for larger models with many symbolic parameters.

Let [symbol] be a field of characteristic 0 where zero-recognition is decidable. The following problems are addressed:

Problem 1. Let f: [symbol] ^{k}→ [symbol] ⁿ be a map with n, kε [symbol] . Do there exist mε [symbol] with m<k, and g: [symbol] ^{m}→ [symbol] ⁿ, h: [symbol] ^{k}→ [symbol] ^{m} such that f=g∘h and h is surjective?

where clearly, if n<k and f is surjective, then we can take m=k, h=f, and g=1 (the identity map). However, for other cases the question seems to be too general to find provable results. Here, we study a special case, a relaxation, and a relaxation of a special case of Problem 1:

Problem 2. Let f: [symbol] ^{k}→ [symbol] ⁿ be a map with n, kε [symbol] . Do there exist mε [symbol] with m<k, a map g: [symbol] ^{m}→ [symbol] ⁿ and a linear surjective map h: [symbol] ^{k}→ [symbol] ^{m} such that f=g∘h?
Problem 3. Let f: [symbol] ^{k}→ [symbol] ⁿ be a map with n, kε [symbol] . Do there exist mε [symbol] with m<k, and g: [symbol] ^{m}→ [symbol] ⁿ, h: [symbol] ^{k}→ [symbol] ^{m} such that f=g∘h and h( [symbol] ^{k}) is dense in [symbol] ^{m} in the Zariski topology?
Problem 4. Let fε [symbol] [x₁, . . . , xₖ]ⁿ, with n, kε [symbol] and n>1, k>1. Do there exist gε [symbol] [y]ⁿ and hε [symbol] [x₁, . . . , xₖ] such that f=g∘h?

Problem 2 is the inside-linear problem, and is solved by assuming we have an oracle for performing certain linear algebra operations on the expressions occurring in f. Problem 3 is called the almost surjective problem; a heuristical algorithm was developed that can provide positive answers to the problem using an oracle for zero testing. Problem 4 is called the uni-multivariate decomposition problem, and is solved completely using a variation of an existing algorithm, modified to achieve a novel purpose. We relax the condition of surjectivity of h here, so that we can, for example, let h:x [symbol] x⁻¹.

Problem 1 is related to the following well-studied problem of polynomial decomposition:

Problem 5. Let f be a polynomial of degree d. Do there exist polynomial maps g and h, both of degree less than d, such that f=g∘h?

For this problem, linear decomposition factors are considered trivial, whereas that is not necessarily the case in any of the other problems discussed here.

Problem 5, which is equivalent to a problem about finding intermediate fields in a proper inclusion of fields, can be studied for different combinations of f, g, and h being univariate and multivariate polynomials. The problem has been solved by others for all univariate polynomials by an exponential time algorithm, improved to quadratic time and to weakly linear time. Further, the polynomial decomposition problem has been generalized by others to rational functions and to algebraic functions.

Applications of the approaches discussed here include the study of mathematical models of physical systems represented by differential equations which incorporate symbolic parameters. The symbolic parameters are constant throughout one simulation of the model (typically, a numerical integration problem), but may vary between runs. For purposes such as calibration, parameter identification, or more generally studying the behaviour of the system as the symbolic parameters vary within a certain space, it can be advantageous to rewrite the differential equations in terms of fewer symbolic parameters while still exhibiting the same behaviour. That is, we first rewrite the model to have few syntactical sub-expressions that involve symbolic parameters; e.g., we collect all polynomial sub-expressions with respect to the symbolic parameters. We then view the resulting parameter sub-expressions as the components of the function ƒ.

A solution to Problem 1 now provides a means of translating the model to one with fewer symbolic parameters: replace the expressions of f (in terms of x, say) by the corresponding ones of g (in terms of h) and translate a parameter setting for the original model to the new one by applying h. This explains why we need h to be surjective: otherwise, the new model can now exhibit behaviour that the old model did not. This also suggests that for this application, it is reasonable to relax the problem to the almost surjective problem: the worst case is then that the new model exhibits behaviour that cannot be reproduced exactly by the old model, but (assuming continuity of the model) it can be approximated arbitrarily well.

Consider the following example ODE:

ż₁(t)=(cos x₁ cos x₂−sin x₁ sin x₂)z₂(t)

ż₂(t)=(cos x₁ sin x₂+sin x₁ cos x₂)z₃(t)

ż₃(t)=x₃^{x}^{₄}z₁(t)+(x₄ ln x₃)z₂(t),

with three state variables zᵢ and four symbolic parameters xᵢ. Reducing the number of symbolic parameters is equivalent to solving Problem 1 for

$$f \text{:} {𝔽}^{4} \to {𝔽}^{4} , ( \begin{matrix}{x}_{1} \\ {x}_{2} \\ {x}_{3} \\ {x}_{4}\end{matrix} ) ↦ ( \begin{matrix}cos {x}_{1} cos {x}_{2} - sin {x}_{1} sin {x}_{2} \\ cos {x}_{1} sin {x}_{2} + sin {x}_{1} cos {x}_{2} \\ {x}_{3}^{{x}_{4}} \\ {x}_{4} ln {x}_{3}\end{matrix} ) .$$

A possible solution would be m=2 with

$$h \text{:} ( \begin{matrix}{x}_{1} \\ {x}_{2} \\ {x}_{3} \\ {x}_{4}\end{matrix} ) ↦ ( \begin{matrix}{x}_{1} + {x}_{2} \\ {x}_{4} ln {x}_{3}\end{matrix} ) , \\ g \text{:} ( \begin{matrix}{y}_{1} \\ {y}_{2}\end{matrix} ) ↦ ( \begin{matrix}cos {y}_{1} \\ sin {y}_{1} \\ exp {y}_{2} \\ {y}_{2}\end{matrix} ) .$$

This solution corresponds to the reparametrization

ż₁(t)=z₂(t)cos y₁

ż₂=z₃(t)sin y₁

ż₃=exp(y₂)z₁(t)+y₂z₂(t),

(as given by g), where y₁=x₁+x₂ and y₂=x₄ ln x₃ (as given by h).

Other methods that can be used for this application include sensitivity analysis, a technique that is more numerical in nature, and dimensional analysis, a technique that works only for so-called physical models which include and respect unit information.

The described algorithms may be run in a computer algebra system such as Maple, which has access to symbolic computation facilities such as automatic differentiation and symbolic linear algebra. In the inside-linear and heuristic approaches, we use such features, treating them as oracles. In these two approaches, we define what the class of expressions is that these oracles operate on; we denote this class by l. We assume that each expression in l has a natural interpretation as a function [symbol] ^{k}→ [symbol] and switch freely between these two interpretations. We will also switch freely between interpreting a map f: [symbol] ^{k}→ [symbol] ⁿ as a vector of maps (f₁, . . . , fₙ), with each fᵢ: [symbol] ^{k}→ [symbol] , and as a single map.

We denote the homogeneous part of degree d of a polynomial p by HomPart_{d}(p). Furthermore, by g[x₁ [symbol] y₁, . . . , xₙ [symbol] yₙ], we denote the expression g where, simultaneously, every occurrence of a variable xᵢ has been replaced by the corresponding expression yᵢ.

The inside-linear algorithm solves Problem 2 using two oracles: JACOBIAN computes the Jacobian of a vector over l, and ROWSPACE factors a matrix Mεl^{n×k} into matrices Aεl^{n×m} and Hε [symbol] ^{m×k} with minimal m, and returns H. Clearly, we need l to be closed under taking derivatives and arithmetic operations; zero-testing of elements of l must be decidable for ROWSPACE to be feasible. The JACOBIAN oracle is generally easy to implement using automatic differentiation techniques. For ROWSPACE, we are in fact computing the row space of the input matrix M. This can typically be implemented probabilistically using floating-point arithmetic, if we have a method for evaluating expressions in l at (random) floating-point values and bounding the error in this computation.

As an alternative, we can take l= [symbol] (x₁, . . . , xₖ). Then ROWSPACE can be implemented as follows: we do Gauss-Jordan elimination; then as long as there is an entry in the result that is not in [symbol] , add a row that eliminates the leftmost such entry and perform Gauss-Jordan elimination again.

We need one more property of l: if fεl and f′(x)=0 identically, then f is a constant map. Let us call this Property (#).

The expression R^{†} in the inside-linear algorithm denotes the Moore-Penrose pseudo-inverse of a matrix R: the (unique) matrix for which RR^{†}R=R, R^{†}RR^{†}=R^{†}, and RR^{†} and R^{†}R are Hermitian (or in particular, symmetric if [symbol] ⊂ [symbol] ).

An example inside-linear algorithm is given below:

```
Algorithm 1 Inside linear algorithm
Input: f: [symbol]   ^{k} → [symbol]   ⁿ
Requires: the entries of f are in l
Output: a decomposition satisfying Problem 2 if there is one, or
  “no decomposition” otherwise
  1: procedure INSIDELINEAR(f)
  2: J ← JACOBIAN(f(x), x)
  3: R ← ROWSPACE(J)
  4: m ← number of rows of R
  5: if m < k then
  6: return f o R^{†}, R
  7: else
  8: return “no decomposition”
  9: end if
10: end procedure
```

Consider the following lemma:

Lemma 6. Let f: [symbol] ^{k}→ [symbol] ⁿ consist of elements of l and let its Jacobian be

$${J}_{f} ( x ) = \frac{\partial }{\partial x} f ( x ) .$$

Suppose there exist a matrix function A: [symbol] ^{k}→ [symbol] ^{n×m} and a matrix Hε [symbol] ^{m×k} with J_{f}(x)=A(x)·H. Then f(x)=f(H^{†}Hx) for all xε [symbol] ^{k}.

Let K=H^{†}H−I, so that f(H^{†}Hx)=f(x+Kx). Let furthermore

pₓ: [symbol] ^{k}→ [symbol] ⁿ,z [symbol] f(x+Kz).

Then p(x)=f(H^{†}Hx) and p(0)=f(x). Note that the Jacobian Jₚ_{ₓ}(z) of pₓ with respect to z can be written as

Jₚ_{ₓ}(z)=J_{f}(x+Kz)·Kz=(A(x+Kz)HH^{†}H−A(x+Kz)H)z=0z=0.

By Property (#), this implies that p(0)=p(x), thus proving the lemma.

Consider the following theorem:

Theorem 7. The inside-linear algorithm correctly solves Problem 2.

If the condition in line 5 is true, then the decomposition returned by the inside-linear algorithm is a valid solution to Problem 2 by Lemma 6. So we assume that the condition is false, that is, m≧k.

By the assumption on the oracles JACOBIAN and ROWSPACE, that implies that there is no matrix Hε [symbol] ^{m′×k} for which the Jacobian J_{f}(x)=A(x)·H and m′<k. By Lemma 6, there is no decomposition f(x)=g(H·x) with such m′. Thus the returned “no solution” is valid.

An example of the inside-linear approach is as follows. Take l= [symbol] (x₁, x₂, x₃) and

$$f \text{:} ( {x}_{1} , {x}_{2} , {x}_{3} ) ↦ ( \frac{27 {x}_{2}^{2} - 36 {x}_{2} {x}_{3} + 12 {x}_{3}^{2} + {x}_{1} + 2 {x}_{2}}{{x}_{1} - {x}_{2} + 2 {x}_{3}} , - \frac{3 {x}_{1} + 6 {x}_{2}}{9 {x}_{2}^{2} + 9 {x}_{1} {x}_{2} - 4 {x}_{3}^{2} - 6 {x}_{1} {x}_{3}} , \frac{2 {x}_{1} + {x}_{2} + 2 {x}_{3}}{3 {x}_{2} - 2 {x}_{3}} ) . \\ Then$$

$$J = {( \begin{matrix}- \frac{( 1 + 9 {x}_{2} - 6 {x}_{3} ) ( 3 {x}_{2} - 2 {x}_{3} )}{{( {x}_{1} - {x}_{2} + 2 {x}_{3} )}^{2}} \\ \frac{54 {x}_{1} {x}_{2} + 108 {x}_{2} {x}_{3} - 27 {x}_{2}^{2} - 36 {x}_{1} {x}_{3} - 60 {x}_{3}^{2} + 3 {x}_{1} + 4 {x}_{3}}{{( {x}_{1} - {x}_{2} + 2 {x}_{3} )}^{2}} \\ - 2 \frac{18 {x}_{1} {x}_{2} + 12 {x}_{2} {x}_{3} + 9 {x}_{2}^{2} - 12 {x}_{1} {x}_{3} - 12 {x}_{3}^{2} + {x}_{1} + 2 {x}_{2}}{{( {x}_{1} - {x}_{2} + 2 {x}_{3} )}^{2}}\end{matrix} \begin{matrix}\frac{3}{{( 3 {x}_{1} + 3 {x}_{2} + 2 {x}_{3} )}^{2}} \\ 3 \frac{9 {x}_{1}^{2} + 18 {x}_{1} {x}_{2} + 18 {x}_{2}^{2} + 12 {x}_{1} {x}_{3} + 8 {x}_{3}^{2}}{{( 3 {x}_{2} - 2 {x}_{3} )}^{2} {( 3 {x}_{1} + 3 {x}_{2} + 2 {x}_{3} )}^{2}} \\ - 6 \frac{( {x}_{1} + 2 {x}_{2} ) ( 3 {x}_{1} + 4 {x}_{3} )}{{( 3 {x}_{2} - 2 {x}_{3} )}^{2} {( 3 {x}_{1} + 3 {x}_{2} + 2 {x}_{3} )}^{2}}\end{matrix} \begin{matrix}\frac{2}{3 {x}_{2} - 2 {x}_{3}} \\ - 2 \frac{3 {x}_{1} + 4 {x}_{3}}{{( 3 {x}_{2} - 2 {x}_{3} )}^{2}} \\ 4 \frac{{x}_{1} + 2 {x}_{2}}{{( 3 {x}_{2} - 2 {x}_{3} )}^{2}}\end{matrix} )}^{T} .$$

The reduced row echelon form of J over [symbol] is

$$( \begin{matrix}1 & 0 & 4 / 3 \\ 0 & 1 & - 2 / 3 \\ 0 & 0 & 0\end{matrix} ) ,$$

so ROWSPACE returns the matrix R consisting of the two nonzero rows of that matrix. Thus m=2<3=k. Then

$${R}^{+} y = ( \begin{matrix}\frac{13}{29} {y}_{1} + \frac{8}{29} {y}_{2} \\ \frac{8}{29} {y}_{1} + \frac{25}{29} {y}_{2} \\ \frac{12}{29} {y}_{1} - \frac{6}{29} {y}_{2}\end{matrix} ) ,$$

We then return

$$( \begin{matrix}\frac{9 {y}_{2}^{2} + {y}_{1} + 2 {y}_{2}}{{y}_{1} - {y}_{2}} \\ - \frac{{y}_{1} + 2 {y}_{2}}{- {y}_{1} - 2 {y}_{2} + {y}_{1}^{2} - 2 {y}_{1} {y}_{2} + {y}_{2}^{2}} \\ \frac{2 {y}_{1} + {y}_{2}}{3 {y}_{2}}\end{matrix} ) , ( \begin{matrix}{x}_{1} + \frac{4}{3} {x}_{3} \\ {x}_{2} - \frac{2}{3} {x}_{3}\end{matrix} ) .$$

The main building block for the algorithm for the uni-multivariate problem is an algorithm that decomposes a single multivariate polynomial in a uni-multivariate way. There are a few algorithms available in the literature that do this; we use Algorithm MULTIVARIATE DECOMPOSITION developed by Gathen et al. in 1990. For the algorithms in the literature, the objective is to have deg(h) be strictly between 1 and deg(f), but for us that is not necessary, and Algorithm MULTIVARIATE DECOMPOSITION handles this gracefully.

The single polynomial problem can be understood as follows: given a multivariate polynomial f, find a multivariate polynomial h such that [symbol] (f)⊂ [symbol] (h)⊂ [symbol] [x₁, . . . , xₖ]. We can view the multivariate Problem 4 as a subfield problem as well: given the multivariate polynomials f₁, . . . , fₙ, is there a multivariate polynomial h such that each [symbol] (fᵢ)⊂ [symbol] (h)? Consider the following theorem:

Theorem 8. Algorithm 2 correctly solves Problem 4.

Let f=(f₁, . . . , fₙ)ε [symbol] [x₁, . . . , xₖ]ⁿ. If a solution (g, h)=(g₁, . . . , gₙ, h)ε [symbol] [y]ⁿ× [symbol] [xᵢ, . . . , xₖ] to Problem 4 exists, then h is a right decomposition factor for each fᵢ, so the total degree of h divides the total degree of each fᵢ. Moreover, any two uni-multivariate decompositions g∘h=g′∘h′ of a multivariate polynomial where deg(h)=deg(h′) are the same up to an invertible linear transformation, so we only need to check at most one candidate right composition factor h for each possible total degree r of h.

Algorithm 2 Uni-multivariate decomposition

```
Input: f ε [symbol]    [x₁, . . . ,xₖ]ⁿ
Requires: no entry of f is constant
Requires: k > 1, n ≧ 1
Output: a decomposition satisfying Problem 2 if there is one, or
  “no decomposition” otherwise
  1: procedure UNIMULTIVARIATE(f)
  2: d ← gcd(total degrees of polynomials in f)
  3: for all divisors r of d do
  4: if MULTIVARIATE DECOMPOSITION (f₁, r) = “no
      decomposition” then
  5: continue to next iteration of for loop on line 3
  6: else
  7: g₁, h ← MULTIVARIATE DECOMPOSITION(f₁, r)
  8: end if
  9: for i ← 2, 3, . . . , n do
10: s ← deg(fᵢ)/r
11: for t ← s, s − 1, . . . , 0 do  # find coefficient of y¹ in gᵢ
12: g_{i,t} ← (HomPartₜ r(fᵢ) − Σⱼ₌ₜ₊₁^{s} g_{i,j} HomPartₜ, r(hⁱ) )/ HomPartₜ
          r(h^{t})
13: if g_{i,t} ∉ [symbol]     then
14: break to next iteration of for loop on line 3
15: end if
16: end for
17: gᵢ = Σⱼ₌₀^{s} g_{i,j}y^{j}
18: if gᵢ(h) ≠ fᵢ then
19: break to next iteration of for loop on line 3
20: end if
21: end for
22: return [g₁, . . . , gₙ],h
23: end for
24: return “no decomposition”
25: end procedure
```

We obtain such a candidate on line 7. In the ith iteration of the loop from lines 9-21, we first compute the coefficients of gᵢ assuming that there is a solution (and verify this solution for the homogeneous components of fᵢ of degrees that are a multiple of r as we go), then verify this on line 18.

Consider the order in which the divisors are examined for the loop from lines 9-21. The proof sketch above does not use any properties of that order, so the result returned is correct whichever order we choose. If the algorithm generates any result, then it is a result with m=1, so the order also does not affect the “performance” in the sense that the reduction is always to 1 variable. The order also does not matter for the worst case time complexity; this occurs if no divisor produces a result.

For the application discussed in the introduction (running mathematical models based on differential equations), it could be advantageous to make the degrees of gᵢ as low as possible, since these expressions need to be evaluated at every time step of a simulation. This would suggest taking the divisors in order of descending magnitude. However, it would be even better to evaluate the expressions gᵢ just once at the beginning of a simulation and substitute these values for the full expressions at that point. If this is implemented, there does not seem to be an advantage to any particular order.

The run time of the uni-multivariate algorithm can be improved by reordering the arguments (f₁, . . . , fₙ). The call to Algorithm MULTIVARIATE DECOMPOSITION always occurs with f₁ as an argument, whereas f₁ is not examined in the loop starting on line 9. Thus it is likely fastest to select a polynomial for f₁ that has the fewest terms and/or the lowest degree among the components of f.

An example follows. Let

$$f = ( \begin{matrix}2 {x}_{1}^{3} - 6 {x}_{1}^{2} {x}_{2} {x}_{3} + 6 {x}_{1} {x}_{2}^{2} {x}_{3}^{2} - 2 {x}_{2}^{3} {x}_{3}^{3} - 3 {x}_{1}^{2} + 6 {x}_{1} {x}_{2} {x}_{3} - 3 {x}_{2}^{2} {x}_{3}^{2} - 3 {x}_{1} + 3 {x}_{2} {x}_{3} - 17 \\ {x}_{1}^{2} - 2 {x}_{1} {x}_{2} {x}_{3} + {x}_{2}^{2} {x}_{3}^{2} - 2 {x}_{1} + 2 {x}_{2} {x}_{3} + 15\end{matrix} ) .$$

The total degrees of f₁ and f₂ are 6 and 4, respectively, so d=2 and r assumes the values 1 and 2, respectively, in the two iterations of the main loop. For r=1, the call to MULTIVARIATE DECOMPOSITION fails, so we retry with r=2. This leads to g₁=−17−3y−3y²+2y³ and h=x₁−x₂x₃. We now enter the inner loop starting at line 9 and try to write f₂ as a polynomial in h. The degree of g₂ would have to be s=2 if this is to work, so we can write g₂=g_{2,0}+g_{2,1}y+g_{2,2}y² with unknown coefficients g_{2,0}, g_{2,1}, g_{2,2}ε [symbol] . The term g_{2,2}y² is the only one that can contribute to the homogeneous degree 4 part of f₂; in particular, g_{2,2}·HomPart₄(h²)=g_{2,2}x₂²x₃² needs to be equal to HomPart₄(f₂)=x₂²x₃². Thus, g_{2,2}=1. Besides g_{2,2}y², the only term that can contribute to the homogeneous degree 2 part of f₂ is g_{2,1}y. In particular, g_{2,1}·HomPart₂(h)+g_{2,2}·HomPart₂(h²)=g_{2,1}x₂x₃+x₁² needs to be equal to HomPart₂(f₂)=x₁²+2x₂x₃, that is,

$${g}_{2 , 1} = \frac{{x}_{1}^{2} + 2 {x}_{2} {x}_{3} - {x}_{1}^{2}}{- {x}_{2} {x}_{3}} = - 2.$$

Similarly, we find that g_{2,0}=15, leading to the candidate left factor g₂=15−2_{y}+y². Since we have so far only ensured equality of the homogeneous components of f₂ and g₂∘h for degrees that are multiples of s=2, we verify by expanding that f₂=g₂∘h. This is indeed true, so we return [−17−3y−3y²+2y³, 15−2y+y²], x₁−x₂x₃.

For obtaining a partial solution to Problem 1, we can also use the heuristic algorithm described herein. We use a subroutine, given by Algorithm 3 and called SOLVE, to solve an equation e(x₁, . . . , xₖ, y₁, . . . , yₘ)−yₘ₊₁=0 for one of a specified set of variables xⱼ that e₁ is affine in, if possible. In particular, we need to have e=e₁xⱼ+e₀, where e₁ and e₀ can be arbitrary expressions involving the other variables subject to e₁ being nonzero in a Zariski-dense subset of [symbol] ^{k+m-1}. In order to test this condition, we require two oracles, called INDEPENDENT and TESTZERO. INDEPENDENT should return true only if its first argument is independent of the second argument and TESTZERO should return false only if its arguments roots are contained in a union of finitely many Zariski-closed proper subsets; in other words, if its argument is nonzero almost everywhere. TESTZERO may return true in this case as well, but it must return true if its argument is zero in a greater subset of the space.

SOLVE should return a solution as a substitution xⱼ [symbol] e₂(x₁, . . . , xⱼ₋₁, xⱼ₊ᵢ, . . . , xₖ, y₁, . . . , yₘ₊₁), or FAIL. Failure does not have to guarantee that a solution does not exist. The subroutine is nondeterministic in that the index j depends on the order in which the variables are tried.

On line 5, we have the oracles INDEPENDENT and TESTZERO test whether a certain expression depends on a variable and whether it is nonzero almost everywhere. This is quite difficult to implement, especially if piecewise expressions are involved. Fortunately, the oracles only need to be sure one way around: INDEPENDENT is allowed to have false negatives and TESTZERO is allowed to have false positives (though the more false positives and negatives there are, the weaker SOLVE will be, and thus Algorithm 4 finds weaker parameter space reductions). This suggests implementing INDEPENDENT using a syntactic test: just check if the given variable occurs in the expression. TESTZERO is a bit trickier; it can be implemented by identifying all piecewise-defined functions and selecting a (random) point inside each branch, then evaluating at all these points. If the results are all nonzero, return false, otherwise true.

```
Algorithm 3 Solving subroutine
Input: e, an algebraic expression
Input: s, a set of variables
Output: either FAIL or a substitution x [symbol]    e′ such that:
  • e[x [symbol]    e′] = 0, and
  • e is linear in x, and
  • x ε s.
  1: procedure SOLVE(e, s)
  2: for all x ε s do
  3: e₀ ← e[x [symbol]    0]
  4: e₁← (e − e₀)/x
  5: if INDEPENDENT(e₁, x) [symbol] [symbol]      TESTZERO(e₁) then
  6: return x [symbol]    −e₀/e₁
  7: end if
  8: end for
  9: return FAIL
10: end procedure
```

Algorithm 3 is called from the main algorithm, Algorithm 4.

Consider the following theorem:

Theorem 9. Algorithm 4 can only return “no decomposition found” or a solution to Problem 3.

Note that h never contains any yⱼ variables. We claim that the following is an invariant of the loop:

(*)g[y₁ [symbol] h₁, . . . , yₘ [symbol] hₘ]=f(x₁, . . . , xₖ).

This is clearly true when entering the loop. The only situation in which it could become false is when the SOLVE-call is successful. That is, gᵢ=g_{i,1}xⱼ+g_{i,0} where g_{i,0} and the nonzero coefficient

Algorithm 4 Heuristical decomposition

```
Input: f: [symbol]    ^{k} → [symbol]    ⁿ
Output: a decomposition satisfying Problem 3, or “no decomposition found”
otherwise
  1: procedure HEURISTIC(f)
  2: g ← f(x₁, . . . , xₖ)
  3: h ← the empty sequence
  4: m ← 0
  5: for i ←1, 2, . . . , n do
  6: if the # of variables xⱼ occuring only in gᵢ is not 1 then
  7: s ← SOLVE(gᵢ − yₘ₊₁, {x₁, . . . , xₖ})
  8: if s ≠ FAIL then
  9: h ← (h, fᵢ)
10: g ← g[s]
11: m ← m + 1
12: end if
13: end if
14: end for
15: s ← variables xⱼ occurring in g
16: h ← (h, s)
17: g ← g with each xⱼ ε s replaced by yₗ such that hₗ = xⱼ
18: if |h| < k then
19: return g, h
20: else
21: return “no decomposition found”
22: end if
23: end procedure
```

g_{i,1} are independent of xⱼ, and the substitution returned is xⱼ [symbol] (yₘ₊₁−g_{i,0})/g_{i,1}. Let us introduce the shorthand y̅ [symbol] h̅ for the sequence of substitutions y₁ [symbol] h₁, . . . , yₘ [symbol] hₘ. For equation (*) to remain invariant after the three assignments, we need to consider

g[xⱼ [symbol] (yₘ₊₁−g_{i,0})/g_{i,1}][ y̅ [symbol] h̅,yₘ₊₁ [symbol] fᵢ]=g[xⱼ [symbol] ((fᵢ−g_{i,0})/g_{i,1})[ y̅ [symbol] h̅], y̅ [symbol] h̅].

The first substitution, xⱼ [symbol] ((fᵢ−g_{i,0})/g_{i,1})[ y̅ [symbol] h̅], just replaces xⱼ by something mathematically equivalent to xⱼ (since gᵢ[ y̅ [symbol] h̅]=fᵢ by (*)). The other substitutions do not change this anymore, because they only change yⱼ variables and ((fᵢ−g_{i,0})/g_{i,1})[ y̅ [symbol] h̅] does not contain such variables anymore. Thus, the result is mathematically equivalent to g[ y̅ [symbol] h̅], which is equal to f by equation (*). We have shown that indeed equation (*) is a loop invariant.

Furthermore, note also that since each hᵢ is linear in some variable xⱼ₍ᵢ₎, it is possible to make hᵢ attain arbitrary values by changing xⱼ₍ᵢ₎ as long as the coefficient is nonzero. This coefficient is independent of xⱼ₍ₖ₎ with k<i and nonzero almost everywhere. Thus, one can obtain arbitrary values for h(x) by starting with any valid value for x, then sequentially changing xⱼ₍ᵢ₎ to obtain the correct value for hᵢ in decreasing order of i. For each i, the complement of the set of values for hᵢ that make the coefficient of any xⱼ₍ₖ₎ in hₖ zero, with k<i, is dense in [symbol] . Hence the image of h is dense.

Note that calling Algorithm 4 on an expression g returned by it may yield a further reduction. In particular, suppose the initial input is

f:(x₁,x₂,x₃,x₄) [symbol] (exp(x₁+x₂),x₁+x₂−ln x₃−ln x₄).

The output of Algorithm 4 would be

h:(x₁,x₂,x₃,x₄) [symbol] (x₁+x₂−ln x₃−ln x₄,x₃,x₄),

g:(y₂,y₃) [symbol] (y₂y₃exp(y₁),y₁).

Calling the algorithm on g would give the output

h′:(x₁,x₂,x₃) [symbol] (x₂x₃exp(x₁),x₁),

g′:(y₁,y₂) [symbol] (y₁,y₂).

This suggests that it may be beneficial to keep iterating Algorithm 4 as long as it is successful.

The heuristic of the algorithm is essentially line 6. Note that this check should probably be implemented using the oracle INDEPENDENT also used in SOLVE.

If gᵢ is the only entry of g that depends on xⱼ, then the dependency of gᵢ on xⱼ represents a proper degree of freedom. Thus it can only be beneficial to introduce a variable yₘ for gᵢ if there are other variables xₖ for which gᵢ is also the only entry of g that it depends on.

It often happens that there are a number of ways to represent a model with fewer symbolic parameters that could be achieved using Algorithm 4, depending on the selection of the solving variable by the oracle, but also on the ordering of the entries in f. For example, suppose f consists of the entries x₁+x₂x₃, x₁+x₂x₃+sin x₃, and x₁+x₂x₃+e^{x3}. If these entries occur in this order, then we get

h:(x₁,x₂,x₃) [symbol] (x₁+x₂x₃,x₃),

g:(y₁,y₂) [symbol] (y₁,y₁+sin y₂,y₁+e^{y2}).

If the first two expressions are reversed, we get

h:(x₁,x₂,x₃) [symbol] (x₁+x₂x₃+sin x₃,x₃),

g:(y₁,y₂) [symbol] (y₁,y₁−sin y₂,y₁−sin y₂+e^{y2}).

Both solutions reduce to two variables, so neither is better than the other in the sense that the resulting value of in is smaller. However, the first is in some sense “cleaner”. In particular, the expression size of both g and h are smaller for the first solution than for the second. Expression size refers to the number of nodes in a directed acyclic graph representation, or alternatively, a tree representation, for an expression. Potential benefits include a better understanding of the decomposition by the user and faster simulation if the model represents a mathematical model involving differential equations (unless the parameter values are substituted before each run). This suggests sorting the entries of f in order of nondecreasing expression size before calling Algorithm 4.

An example of the heuristic approach is shown below. Let

f=(x₂²x₃,x₁+sin x₂,x₁+x₄²+sin x₂,x₁+sin x₂+x₂²x₃x₄x₅).

The initialization steps lead to g being equal to f, h being equal to the empty sequence; and m being 0. In the first iteration of the loop, both x₂ and x₃ occur in other entries of g, so we solve x₂²x₃−y₁=0 to x₃=y₁x₂⁻². Thus we set h=(x₂²x₃),

g=(y₁,x₁+sin x₂,x₁+x₄²+sin x₂,x₁+sin x₂+y₁x₄x₅),

and m=1.

In the second iteration of the loop, both x₁ and x₂ occur in other entries of g, so we solve x₁+sin x₂−y₂=0 to x₁=y₂−sin x₂. This leads to h=(x₂²x₃x₁+sin x₂),

g=(y₁,y₂,y₂+y₄²,y₂+y₁x₄x₃),

and m=2. Note that g depends on only four variables now; we have managed to reduce the number of variables. This would not have been possible if the substitution x₃=y₁x₂⁻² had not been performed before.

In the third iteration of the loop, x₄ occurs in another entry of g, so we attempt to solve y₂+x₄²−y₃=0 but fail. Finally, in the fourth iteration, x₄ does occur in another entry, but x₅ doesn't, so we do not attempt the solution step.

We set s={x₄, x₅} and h=(x₂²x₃,x₁+sin x₂,x₄,x₅). Then g is changed to

(y₁,y₂,y₂+y₃²,y₂+y₁y₃y₄).

Finally, since k=5 and h has four entries, we return g, h.

In conclusion, several approaches to partially solving Problem 1 were developed. For a real-life implementation, a given problem (such as a system of DAEs) may be separated into independent subproblems, then each of the applicable algorithms tried on each subproblem, the best result selected. This may be achieved using a meta-algorithm as described above.

For studying differential equation systems with symbolic parameters, an additional step may be included. In particular, the uni-multivariate and heuristical algorithms are applied to expressions that are polynomials in the symbolic parameters, or to general expressions containing only symbolic parameters, respectively; otherwise, the definition of the new symbolic parameters may contain non-parameter variables, in which case their value would not be constant throughout one simulation. Thus in order to apply these algorithms to a system of differential equations, preferably one first extracts sub-expressions of these equations consisting only of symbolic parameters, or only of polynomials in the symbolic parameters, and then apply the algorithm to these sub-expressions.

The inside-linear algorithm can deal with expressions involving arbitrary variables such that only linear combinations of the original symbolic parameters are used as new symbolic parameters. An approach to achieve this is to consider the other variables as arbitrary elements of l, not inputs to the map f.

In order to better teach the invention but not limit its scope in any way, an illustrative example of extracting symbolic parameter sub-expression for a plurality of DAEs is discussed below.

Assume a model for a physical system contains the following dynamic equations:

$$\begin{matrix}\frac{d}{d t} x ( t ) = x ( t ) \cdot p + x ( t ) \cdot q - x ( t ) \cdot a + y ( t ) \cdot s & ( 1 ) \\ and & \\ \frac{d}{d t} y ( t ) = sin ( ( p + q + a ) \cdot y ( t ) ) - x ( t ) & ( 2 )\end{matrix}$$

It is appreciated that equations 1 and 2 are symbolic equations since they contain the symbols x, y, t, p, q, a, s. Also, x(t) and y(t) are dynamic variables since they depend on t (time) and p, a, q, s are symbolic parameters since they do not depend on t. Stated differently, the variables vary over time while the symbolic parameters do not. Furthermore, the symbolic parameters p, a, q, s are symbolic since their values are not known at this time, i.e. a design point has not been assigned to any of the symbolic parameters.

Equation 1 can also be written as:

$$\frac{d}{d t} x ( t ) = ( - a + p + q ) \cdot x ( t ) + y ( t ) \cdot s \qquad ( 3 )$$

which allows a grouping of the symbolic parameters from Equations 2 and 3 into parameter sub-expressions of p+q+a, −a+p+q and s. The sub-expressions can also be expressed as:

sub-expressions=[p+q+a,−a+p+q,s] (4)

This group of sub-expressions (4) can further be divided into two groups of symbolic parameter sub-expressions that contain the same symbolic parameters and which we define as clusters. For example:

cluster₁=[p+q+a,−a+p+q] (5)

cluster₂=[s] (6)

It is appreciated that a cluster is not the same as a term, e.g. clusterₛ or cluster₂ is not the same as the term or terms x(t)·p, x(t)·a, etc., from Equation 1 or sin((p+q+a)·y(t)) and x(t) from Equation 2. In addition, the inventive method disclosed herein establishes such clusters such that an exact parameter algorithm can be executed thereon and afford for a parameter reduction, i.e. a reduction in the total number of symbolic parameters. For example, cluster₁ can be written as:

cluster₁-reduced=[r+a,−a+r] (7)

where r=p+q and thus r is also a symbolic parameter. In addition, cluster₁-reduced allows Equations 2 and 3 to be written as Equations 8 and 9, respectively:

$$\begin{matrix}\frac{d}{d t} y ( t ) = sin ( ( r + a ) \cdot y ( t ) ) - x ( t ) & ( 8 ) \\ and & \\ \frac{d}{d t} x ( t ) = ( - a + r ) \cdot x ( t ) + y ( t ) \cdot s & ( 9 )\end{matrix}$$

As such, the total number of symbolic parameters is reduced from four (p, q, v, s) to three (r, v, s). Furthermore, the symbolic parameter r is a combination of original symbolic parameters p and q.

The above reduction in symbolic parameters is an example of a linear decomposition. Regarding uni-multivariate decomposition, an example is shown below, starting with an example of uni-multivariate composition.

Assume that r is a symbolic parameter and is part of a model for a physical system. Furthermore, assume the following expression is at least part of the model:

h(r)=r²+2r−3 (10)

and r is defined in terms of u, v, w as:

r=g(u,v,w)=v²+u−3w (11)

As such, h(r) can be expanded in terms of u, v, w as:

h(g(u,v,w))=f(u,v,w)=(v²+u−3w)²+2v²+2u−6w−3 (12)

which in turn is equal to:

f(u,v,w)=v⁴+2uv²−6v²w+u²−6uw+2v²+9w²+2u−6w−3 (13)

It is appreciated that uni-multivariate decomposition is simply the opposite process as shown above, i.e. the inventive method starts with a model for a physical system that is defined at least in part by Equation 13. Equation 13 is then decomposed into Equation 10 and a revised model containing only one symbolic parameter r is created from the original model containing three symbolic parameters u, v, w. It is appreciated that uni-multivariate composition is relatively easy for one skilled in the art, however uni-multivariate decomposition is difficult, even for the simple example provided above. As such, use of the inventive uni-multivariate decomposition algorithm disclosed herein allows for major reductions in model complexity and thus significant reductions in computation time for simulation of physical models.

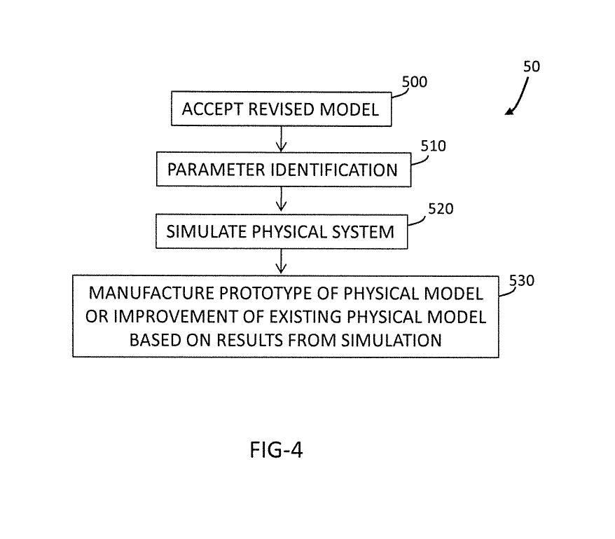

Referring now to FIG. 4, an example of a predetermined model for a physical system in the form of a direct current (DC) motor 40 is discussed below.

The DC motor 40 can be defined by a model that includes the following three equations:

$$\begin{matrix}\frac{d}{d t} {L}_{RB} ( t ) = - {K}_{E} \cdot i ( t ) & ( 14 ) \\ \frac{d}{d t} i ( t ) = \frac{1}{{L}_{I}} [ \frac{- J \cdot R \cdot i ( t ) + {K}_{E} \cdot {L}_{RB} ( t )}{J} + v ( t ) ] & ( 15 ) \\ and & \\ \frac{d}{d t} {E}_{T} ( t ) = R \cdot {i ( t )}^{2} - P ( t ) & ( 16 )\end{matrix}$$

Furthermore, P(t) can be defined as:

$$P ( t ) = \frac{1}{c \cdot m} [ {k}_{R} \cdot \{ - c \cdot m \cdot {T}_{a} + {E}_{T} ( t ) \} ] \qquad ( 17 )$$

As such, the model of the DC motor 40 includes five variables: L_{RB}(t) which is the angular momentum in units of kg m²/s of the DC motor shaft 420; i(t) which is the current in amps (A) through the inductor 400, v(t) which is the voltage in volts (V) of the voltage source 440, E_{T}(t) which is the thermal energy in joules (J) of the thermal resistor 410, and P(t) which is the power flow in watts (W) from thermal resistor 410 to the thermal sink 412.

The model also includes eight symbolic parameters: K_{E} which is the EMF constant in units of V·s, L_{I} which is the inductance in henry (H) of the inductor 400, J which is the moment of inertia in units of kg·m² for the motor shaft 420, c which is the specific heat capacity in units of J/(K·kg) of thermal resistor, k_{R} which is the thermal conductivity in watts per degree kelvin (W/K) of the thermal resistor 410, m which is the mass in kilograms (kg) of the thermal resistor 410, R which is resistance in ohms (Ω) of the thermal resistor 410, and Tₐ which is the atmospheric or ambient temperature in kelvin (K) at the thermal sink 412.

By defining:

$${Θ}_{1} = \frac{{k}_{R}}{c \cdot m} and {Θ}_{2} = c \cdot m \cdot {T}_{a}$$

P(t) can be expressed as:

P(t)=Θ₁[−Θ₂+E_{T}(t)] (18)

As such, the system has been reduced from 8 to 6 symbolic parameters before simulation begins and before parameter values, i.e. design points, are assigned.

In the alternative, symbolic parameter sub-expressions can include:

$$sub \text{-} expressions = [ - {K}_{E} , \frac{1}{{L}_{I}} , - \frac{J \cdot R}{J} , \frac{{K}_{E}}{R} , R , \frac{1}{c \cdot m} , {k}_{R} , - c \cdot m \cdot {T}_{a} ]$$

This group of sub-expressions can further be divided into groups of symbolic parameter sub-expressions that contain the same symbolic parameters, i.e. clusters:

$${cluster}_{3} = [ - {K}_{E} ] ;$$

$${cluster}_{4} = [ \frac{1}{{L}_{I}} ] ;$$

$${cluster}_{5} = [ \frac{J \cdot R}{J} , \frac{1}{R} , R ] ; and$$

$${cluster}_{6} = [ \frac{1}{c \cdot m} , {k}_{R} , - c \cdot m \cdot {T}_{a} ] .$$

Again defining:

$${Θ}_{1} = \frac{{k}_{R}}{c \cdot m} and {Θ}_{2} = c \cdot m \cdot {T}_{a}$$

allows cluster 6 to be reduced to:

cluster₆-reduced=[Θ₁,−Θ₂]

and again the eight symbolic parameters K_{E}, L₁, J, c, k_{R}, m, R, Tₐ are reduced down to six symbolic parameters K_{E}, L₁, J, R, Θ₁, Θ₂, and P(t) can be expressed as:

P(t)=Θ₁[−Θ₂+E_{T}(t)] (18)

Once the revised model has been generated, the revised model—now having six symbolic parameters instead of eight symbolic parameters—can be used to simulate a DC motor that adheres to Equations 14-17. In addition, the results of the simulation, which can include a plurality of simulation runs, can be used as data to manufacture a prototype of the DC motor, or in the alternative, to manufacture an improved DC motor of an existing DC motor.

FIG. 4 illustrates a process 50 in which the revised model is accepted by the computer 30 at step 500. At step 510 actual parameter identification is executed, e.g. finding suitable numerical values/design points for the revised model is provided and the revised model is used to simulate the physical system at step 520. Finally, results from the simulation are used to manufacture a prototype of the physical model or manufacture an improvement of an existing physical model at step 530.

Examples disclosed herein include methods performed by a computer algebra system capable of symbolic mathematics, such as a virtual engineering environment. A virtual engineering environment may comprise one or more processors, memory components such as volatile and/or non-volatile memory components, and one or more communications interfaces such as a display, data entry components, and the like. A virtual engineering computer may then simulate a time-dependent physical system using the revised model obtained using an example of the present invention.

The invention is not restricted to the illustrative examples described above. Examples described are not intended to limit the scope of the invention. Changes therein, other combinations of elements, and other uses will occur to those skilled in the art. The scope of the invention is defined by the scope of the claims.

Having described our invention, we claim:

1. A method for designing and manufacturing a prototype of a physical system or improving an existing physical system, the method comprising:
providing an initial model of the physical system, the initial model having a plurality of differential algebraic equations (DAEs), the plurality of DAEs having a plurality of variables and a plurality of symbolic parameters;
receiving the initial model of the physical system within a specifically configured computational environment having at least one processor, the specifically configured computational environment executing the following steps:
a. extracting symbolic parameter sub-expressions from the plurality of DAEs;
b. establishing at least one initial cluster of symbolic parameter sub-expressions;
c. executing a parameter reduction algorithm on the symbolic parameter sub-expressions of the at least one initial cluster;
d. generating at least one reduced cluster having a reduced number of symbolic parameter sub-expressions compared with the at least one initial cluster using the parameter reduction algorithm, the reduced number of symbolic parameter sub-expressions being a combination of the symbolic parameter sub-expressions of the at least one initial cluster;
e. creating a revised model using the at least one reduced cluster, the revised model having fewer symbolic parameter sub-expressions than the initial model;
f. modeling the physical system with the revised model having fewer parameter sub-expressions, the modeling of the physical system a having a reduction in computation time compared to modeling of the physical system using the initial model of the physical system;
and
manufacturing a prototype of the physical system or an improved version of an existing physical model as a function of results obtained from the modeling of the physical system with the revised model.

2. The method of claim 1, wherein the at least one initial cluster is a plurality of initial clusters with each initial cluster having a plurality of initial symbolic parameters sub-expressions.

3. The method of claim 2, wherein the exact parameter reduction algorithm is executed on each of the plurality of initial clusters.

4. The method of claim 3, wherein the parameter reduction algorithm is selected from the group consisting of a linear decomposition algorithm, a uni-multivariate polynomial decomposition algorithm and a heuristical decomposition algorithm.

5. The method of claim 4, wherein the parameter reduction algorithm is the linear decomposition algorithm.

6. The method of claim 4, wherein the parameter reduction algorithm is the uni-multivariate decomposition algorithm.

7. The method of claim 4, wherein the parameter reduction algorithm is the heuristical decomposition algorithm.

8. The method of 3, wherein the parameter reduction algorithm includes a linear decomposition algorithm, a uni-multivariate polynomial decomposition algorithm and a heuristical decomposition algorithm;
executing the linear decomposition algorithm, the uni-multivariate polynomial decomposition algorithm and the heuristical decomposition algorithm on each of the plurality of initial clusters, each of the executed algorithms generating a separate cluster of symbolic parameter sub-expressions; and
selecting at least one reduced cluster from the separate clusters of symbolic parameter sub-expressions, the selected at least one reduced cluster having a minimum number of symbolic parameter sub-expressions.

9. The method of claim 1, further including removing all isolated symbolic parameters from the model before establishing initial clusters of parameter sub-expressions.
